(19) United States
(12) Patent Application Publication
(10) Pub. No.: US 2005/0175177 A1
(43) Pub. Date: Aug. 11, 2005

(54) Watermark detection

(75) Inventor: Henricus Antonius Gerardus Van Vugt, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKILJKE PHILLIPS ELECTRONICS N.V

(21) Appl. No.: 10/516,149

(22) PCT Filed: Jun. 4, 2003
(86) PCT No.: PCT/IB03/02476

(30) Foreign Application Priority Data
Jun. 4, 2002 (EP) 02012255.2

(51) Int. Cl. H04N 7/167

(52) U.S. Cl. 380/201

(57) ABSTRACT

Disclosed is a solution for connecting an existing MPEG2-compliant watermark detector (20), that accepts MPEG2 video data up to a certain data rate, to a PC-DVD drive. Problem is that the data rate of the standard IDE/ATAPI bus (3) is much higher than the watermark detector can handle. The solution is to store MPEG slices in a data buffer (214), and throw away (212) slices that do not completely fit in the buffer. Non-slice data is never removed. This results in an MPEG2-compliant stream at a lower rate which the detector (20) can handle.

### FIELD OF THE INVENTION

The invention relates to a method and arrangement for detecting a watermark in an information signal, such as an MPEG compressed video signal. The invention also relates to an interface circuit for interfacing a watermark detector to a communication bus over which a possibly watermarked information signal is transferred from one device to another device, for example, an IDE/ATAPI bus connecting a DVD drive to a PC.

### BACKGROUND OF THE INVENTION

Watermarking is a technique to certify the ownership of (digital) information content. By imperceptibly hiding a watermark into the content, it is possible to prevent piracy and illegal use of this content. Typical applications include copy protection for digital audio and video.

An example of a prior art watermarking system is disclosed in International Patent Application WO-A-99145707. The prior art method relates to watermarking a motion video signal. The watermark (a secret pseudo random noise sequence) is added to the content in the spatial signal domain. For complexity reasons, the same watermark is embedded in every image (field or frame) of the video signal. To reduce the complexity even more, a small watermark pattern is tiled over the image. A typical tile size is 128×128 pixels. At the detection side, the tiles of a number of images are folded into a 128×128 buffer. Detection is performed by correlating the buffer contents with the pseudo random noise sequence. If the correlation exceeds a given threshold, the watermark is said to be present.

Watermark detectors have been developed that detect a watermark in an MPEG2 compressed video signal. They have been designed to handle real-time MPEG2 bit streams up to a given bit rate, for example 100 Mbit/sec. Although this rate is larger than the typical data rate of a real time video signal, it is far from sufficient to handle the data rates that presently occur in personal computers where video signals are read from (and recorded on) CD or DVD drives through the IDE/ATAPI interface at speeds exceeding 500 Mbit/sec.

### OBJECT AND SUMMARY OF THE INVENTION

It is an object of the invention to provide a method of detecting a watermark in an information signal being transferred from one device to another over a high-speed interface bus, using a watermark detector operating at a lower speed.

This is achieved by the method and arrangements as defined in the appended claims, description and accompanying drawings.

The invention is particularly applicable to watermark detection in video signals being compressed in accordance with one of the MPEG video compression standards. In said standards, portions of an image are represented by so-called slices. In accordance with the invention, some of such image portions are filtered out (i.e. thrown away) so as to reduce the signal's data rate. The invention is based on the insight that an MPEG bit stream from which individual slices have been removed still complies with the MPEG standard. Accordingly, the filtered signal having the reduced data rate can still be processed by an MPEG-compliant watermark detector.

### BRIEF DESCRIPTION OF THE DRAWINGS

FIG. 1 shows schematically a system comprising a PC with a DVD drive including an arrangement according to the invention.

FIG. 2 is a block diagram of the watermark detector being implemented in the DVD drive.

FIGS. 3 and 4 are more detailed schematic diagrams of the watermark detector which is shown in FIG. 2.

FIGS. 5 and 6 are flow diagrams illustrating the processes performed by the watermark detector which is shown in FIG. 2.

### DESCRIPTION OF EMBODIMENTS

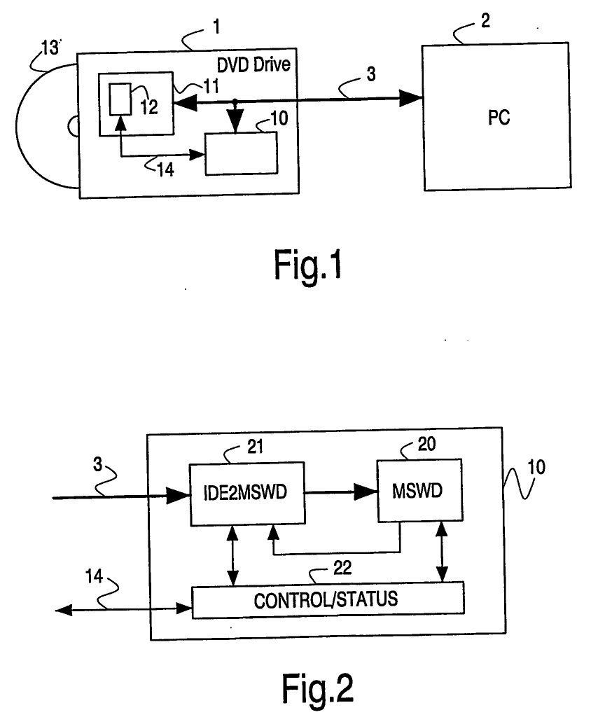

A preferred embodiment of a watermark detection method and arrangement in accordance with the invention will now be described with reference to a personal computer (PC) provided with a Digital Versatile Disk (DVD) drive. In FIG. 1, reference numeral 1 denotes the DVD drive and reference numeral 2 denotes the (rest of the) PC. The DVD drive and PC are interconnected in a conventional manner by means of a bi-directional IDE/ATAPI communication bus 3. The DVD drive 1 comprises a conventional electronic drive circuit 11 for controlling the transfer of data to and from a DVD disc 13 under control of a microprocessor 12. The DVD drive further comprises a watermark detector 10, which is connected to the EDE/ATAPI bus 3 so as to monitor the transfer of media content and control signals between DVD drive and PC without interfering with such data transfers. The watermark detector 10 is further connected to the microprocessor 12 through a data communication bus 14, for example, the well-known I²C bus.

In accordance with a preferred embodiment of the invention, the watermark detector 10 is a stand-alone device being placed on the DVD drive's printed circuit board. However, it can be placed wherever the IDE/ATAPI bus is, for example on the PC's main board or inside IDE/ATAPI drives of a different type, e.g. CD or harddisk. It is also possible to integrate the watermark detector into an existing chip that already contains the IDE/ATAPI interface logic of a drive.

On a DVD disc, video is compressed according to the MPEG2 standard and stored as a ‘DVD Program Stream’. The watermark detector 10 monitors all data that is being transferred via the IDE/ATAPI interface, and is arranged to interpret the DVD Program Stream whenever it sees this type of data. Only the video part (‘Video Elementary Stream’) is of interest to the detector. It makes no difference if video data is being played or being copied, in both cases it is transferred over the IDE bus.

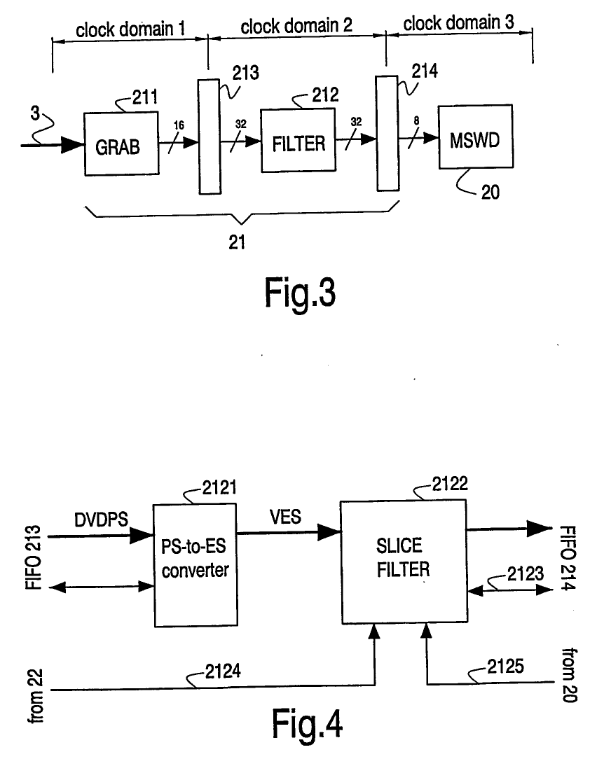

FIG. 2 shows a schematic diagram of the watermark detector 10. Heart of the detector is a watermark detector core 20, which is a conventional watermark detector in the sense that it has been designed to detect a watermark in real-time MPEG2 bit streams up to a given bit rate. The detector core 20 will further be referred to as MPEG Scale-resistant Watermark Detector (MSWD). It will be assumed that the detector core operates at a rate of 1 bit per clock cycle. Even if the detector core is operated at high frequencies (say 100 MHz, in which case it can handle bit streams up to 100 Mbit/sec), there is the problem that the IDE data rate can be much higher. In UDMA mode, an IDE bus transfers data at max. 33.33 million 16-bit data words per second, i.e. over 500 Mbit/sec.

To this end, the watermark detector 10 further comprises an IDE-to-MSWD interface module 21, which is connected between the ‘high-speed’ IDE bus 3 and the ‘low-speed’ detector core 20. Its two major functions are (1) dealing with the different data rates, and (2) dealing with different clock domains (the MSWD might run at another clock frequency than for example IDE related logic).

The preferred embodiment of the watermark detector 10 deals with the different data rates by throwing away a certain amount of MPEG2 data if the incoming data rate is more than the MSWD can handle. This process is hereinafter also referred to as filtering. The chosen approach is to throw away complete MPEG slices if, at the start of such a slice, it turns out that there is not sufficient room in a data buffer to store the complete slice. If a slice is removed from the stream, it is removed from the very first to the very last bit. Non-slice data is never removed. All of this results in a ‘valid’ MPEG2 stream, which is essential because that is what the detector core 20 can handle. The expression ‘not sufficient room in the data buffer to store the complete slice’ implies that there is an assumption regarding the maximum size of a slice, because at the start of a slice the length is yet unknown. In practice 4 Kbyte seems to be a good value. If at a certain moment a slice occurs that exceeds the assumed maximum length, then the MPEG stream that enters the detector core will typically run into variable-length decoding errors, from which it will automatically recover by searching for a next valid MPEG2 start code.

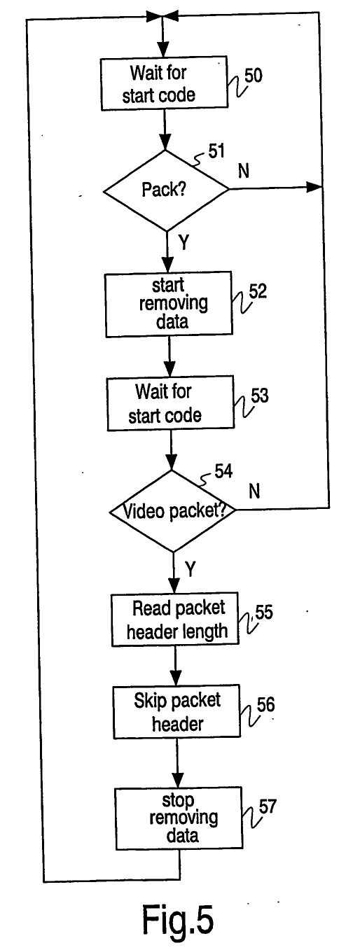

When dealing with different clock domains, a distinction can be made between three potentially different clock domains. This is illustrated in FIG. 3, which shows more details of the IDE-to-MSWD interface module 21. At one end there is IDE related logic 211 which performs grabbing of the DVD data stream. At the other end there is the MSWD 20 which performs the actual watermark detection. In between there is logic 212 that does the MPEG filtering. The clock domains are separated by means of two first-in-first-out buffers (FIFO's) 213 and 214 that handle the different clock rates as well as different data bus widths.

The FIFO 214 between the MPEG filtering part and the MSWD is the one that is also being used for handling the different data rates involved. It therefore has to have a certain storage capacity, which is preferably at least twice the assumed maximum size of incoming slices, so 8 Kbyte or more. From the WE bus up to the input of this FIFO 214 everything runs at full speed, meaning that all logic in front of this FIFO can keep up with the maximum data rate on the WDE bus.

The FIFO 213 between the IDE bus and the MPEG filtering part can be very small, because the MPEG filtering part is made such that it reads faster than the EDE logic can write. Partly this is realized by letting the MPEG filtering part handle 32 bits at a time, while the WDE bus width is only 16 bits. The existing watermark detector core 20 has an 8-bit input, accepting 1 unit per 8 clock cycles.

The logic 211 between the IDE bus and the input of the first FIFO 213 has the task of ‘grabbing’ all relevant data that is being transferred over the IDE bus, and to write this data into the FIFO. Data is considered ‘relevant’ if it comes from disc or goes to disc. So for example all data that is being returned by the drive upon receiving the ATAPI ‘READ’ command is considered relevant, as well as all data that is sent along with a ‘WRITE’ command Data related to commands like ‘INQUIRY’, ‘REQUEST SENSE’, etc. should be discarded. The same is true for IDE overhead at the lowest level (commands, control/status), which is also transferred over the IDE data bus.

It is important that all commands that transfer data to or from disc are recognized, in order to prevent an easy hack to the system. It is also important that all the different IDE modes are supported, ranging from ‘PIO mode 0’ up to ‘UDMA mode 4’. In general all possible modes of operation must be covered, for example operating the IDE bus with or without interrupts. Basically the IDE part is one big state machine.

Optional logic between the second FIFO 214 and the MSWD detector core 20 (not shown in FIG. 3) does nothing more than providing the MSWD with new data whenever possible, which is when the FIFO is not empty and at least 8 clock periods have passed since the previous transfer (detector core can handle only one bit per clock cycle).

The logic 212 between the two FIFO's 213 and 214 has the task of ‘filtering’ out data that is not to be sent to the detector core. FIG. 4 shows a more detailed schematic diagram of this filtering logic block. It comprises a stream converter 2121 that converts an ‘DVD Program Stream’ (D)VDPS) into and ‘MPEG2 Video Elementary Stream’ (VES). If there is no DVD Program Stream data at the input (e.g. when copying a document) nothing will come out. It further comprises a slice filter 2122, which is capable of filtering out complete MPEG2 slices. It does so whenever dynamically required, for example, at moments that there is no more room in output FIFO 214 for another slice. Such information is conveyed from the FIFO to the module via control lines 2123. It also does so when instructed to do so by the application (user), which may for example request to remove all slices from I- and/or P- and/or B-pictures, or all slices below a certain vertical position and/or above another. This gives the possibility of fine-tuning the system. Such instructions are stored in a control/status register 22 (see FIG. 2), and conveyed to the slice filter 2122 via control lines 2124.

Instructions for removal of certain slices can also come from the detector core 20. If for example the detector core is accumulating data located in a fixed area around the middle of the screen (doing for example horizontal scale detection), then it makes no sense to fill the output FIFO with data coming from outside this area. It would be thrown away later by the detector core. Vertically this is prevented by having an appropriate feedback path from the detector core to the slice filter. Such instructions are conveyed to the slice filter 2122 via control lines 2125.

Variable-length decoding is not necessary to be done inside the IDE-to-MSWD interface block. This greatly reduces the complexity. The penalty is that it is not possible to throw away macro blocks outside certain horizontal boundaries.

MPEG2 chunks at the input of the DVDPS-to-ES converter 2121 are longword-aligned (longword=4 bytes), because each DVD Program Stream sector begins with a so-called ‘pack’ start code (hex. 00 00 01 BA). At the output (Video Elementary Stream) MPEG2 chunks are byte-aligned. For this reason the DVDPS-to-ES converter incorporates logic to do byte ‘routing’. The same is true for the slice filter 2122, where complete slices (multiple of 1 byte) are removed.

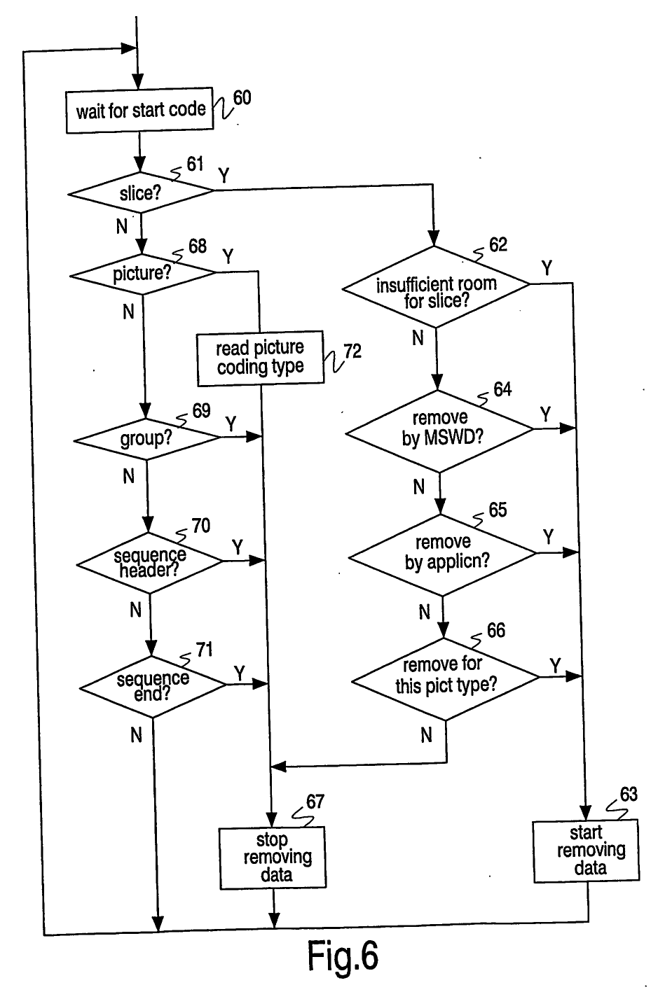

The PS-to-ES converter 2121 produces a Video Elementary Stream by removing ‘pack headers’ and ‘packet headers’ (plus any non DVD Program Stream data) from the input stream. Besides the routing of bytes this operation is quite straightforward. FIG. 5 shows a flow diagram of the conversion process. In a step 50, the converter monitors the received Program Stream to find a start code. In a step 51, it is checked whether the start code is the pack start code hex 00 00 01 BA. As long as that is not the case, the converter returns to the step 50. When the pack start code is detected, the converter starts (or continues as the case may be) removing all subsequent data from the Program Stream (step 52). When a further start code is found (step 53), it is checked (step 54) whether said start code has the value hex 00 00 01 E0 identifying the start of a video packet. If that is the case, the converter reads the packet header length (step 55), and skips the packet header (step 56). The removal of data is now stopped (step 57), so that the rest of the data stream, which constitutes an MPEG2 elementary video stream, is passed to the slice filter 2122 (FIG. 4) until a new pack start code is detected in the steps 50 and 51.

The slice filter 2122 converts one Video Elementary Stream into another. The output stream equals the input stream, except for the fact that complete slices are removed when there is not enough room in buffer 214 for another complete slice (signaled via control data line 2123), when not needed as indicated by detector core 20 (via control data line 2125) or when requested by the application (via control data line 2124). Data removal always starts with the very first byte of a slice, being the first byte of the slice start code. Data removal always ends with the very last byte of a slice, being the last byte before one of the following start codes: picture start, group start, sequence header or sequence end.

FIG. 6 shows a flow diagram of the operations carried out by the slice filter 2122. While the video elementary stream is being received, the filter waits for the occurrence therein of a start code (step 60). In a step 61, it is checked whether the start code is a slice tart code (hex 00 00 01 01). If that is the case, it is checked whether there is sufficient space in the FIFO 214 for a complete slice (step 62). In there is insufficient room, a step 63 is performed in which the filter starts removing subsequent data including the start code just detected. The step 63 is also carried out if there is sufficient room in the FIFO, but:
the MSWD wants to throw away any slices at a particular (vertical) position in the image (step 64),
the application wants removal of slices at a particular position (step 65), or
the application requests slices from (a) particular picture type(s) only (step 66).

If it was determined, in the step 62, that there was sufficient space in the FIFO for the new slice, and neither the MSWD nor the application wanted to throw it away (steps 64-66), then a step 67 is carried out in which the removal of data is stopped. The step 67 thus causes the process of passing on the video elementary stream to the output to be resumed (or continued as the case may be).

The step 67 of resuming or continuing the process of writing the stream into the FIFO 214 is also carried out if the start code found in the stream is a picture start code (step 68), a group start code (step 69), a sequence header start code (step 70), or a sequence end start code (step 71). Upon the start of a new picture, the coding type of said picture (I, P, B) is determined in a step 72. The result of this determination is used in the step 66.

A major assumption for the above-described stand-alone solution is that the number of ‘micro-decisions’ per time unit (at the side of the detector core) does not have to keep up with the speed of copying at all times. At a certain moment when going to higher data rates MPEG data will be thrown away and the number of micro-decisions per time will no longer increase. The clock-frequency of the MSWD detector core determines the (speed) performance of the total watermark detector. The detector core handles one MPEG bit per clock cycle. So if it would be running at for example 80 MHz the maximum bit-rate would be 80 Mbit/sec, meaning that the detector can keep up with approximately 8 times DVD speed (n=8). In the case that gate-count and memory-size are not an issue, it is possible to have more than just one MSWD detector core. This would allow to go to n=16 or above. Each detector core would require its own FIFO. The slice filter module 2122 would have to take care of data distribution (each time looking which of the FIFO's has room for another complete slice).

The paragraphs above are related to average speed. Also very important are the data rate within IDE data bursts and the size of these bursts. If the data rate within bursts is very high (higher than that of the detector core) and the size of bursts is very large (larger than the available buffer), then each time a burst occurs the buffer is quickly filled and remaining data is then thrown away. If the distance between bursts is very high, the detector core finishes reading of the buffer before the next burst arrives. This leads to loss of performance (detector core not always occupied, yet data is being thrown away). All of course depends on the size of the buffer. If it is big enough to store a complete burst then no data is wasted.

Another major assumption for the stand-alone solution described above is that access to the PC drive is sequential by nature, which covers playback and ‘normal’ copying of video sequences. If access is not purely sequential, then performance will typically drop. Performance in this case means watermark reliability values (not the micro-decision rate). One example of non-sequential access is when during video playback the drive is being accessed by a second application. Data belonging to the two separate data streams is accumulated by the detector core in one and the same buffer. If both are parts of an equally watermarked video sequence then there is no real problem. Detection performance might even be higher in that case (less data correlation and/or higher IDE data rate). If one data stream is watermarked video and the other data stream is video that has not been watermarked, then the micro-decision rate might be higher (due to higher IDE data rate) but reliability values will be lower (due to less relative watermark contribution). If the other data stream is not DVD Program Stream, and is therefore discarded, the only influence could be a lower micro-decision rate (less IDE bandwidth available for the video stream).

In normal circumstances (video playback/‘normal’ copying) an application requests several DVD sectors at the same time. Typically an ECC block, being 8 sectors or 32 Kbyte. This amount of sequential data (several MPEG slices) is sufficient for the detector core to do quite some MPEG interpretation and following data accumulation, even when such a request is preceded and/or followed by totally different requests. General experiments show that it is remarkably difficult to prevent occasional watermark detection by trying to disturb access to the video sequence that contains this watermark.

Another example of non-sequential access is when an application (the user) deliberately does random reading of single sectors. In that case the stand-alone solution might detect a watermark once in a while, but in general performance will be very poor. For this kind of activities a different architecture is required. A result of non-sequential access can also be that multiple watermarks are detected (at the same time) that do not belong to the same video part. Probably the best way to deal with this is to take action according to the most ‘severe’ watermark.

It will typically make no difference at what speed a certain watermarked video sequence is being accessed, as long as access is sequential and data is not mixed with other data. Reliability can even go up when going to higher speeds, because when more slices are thrown away there is less video data correlation. Less video data correlation means that it is easier to detect (a) possible watermark(s).

The algorithmic specification that belongs to the MSWD detector core describes how much data should be accumulated during scale detection and during actual watermark detection. For actual watermark detection different situations exist, depending on the scale that is being used. In all cases the amount of data that is to be accumulated is expressed as a number of (I- and/or P- and/or B-) pictures. For the stand-alone solution described here this must be changed, because a number of pictures doesn't say anything any more about the amount of data that is accumulated. For example during copying at a data-rate four times higher than the MSWD detector core can handle, a typical picture at the input of this detector core will only contain one quarter of the original number of slices. For this reason, the MSWD detector core can be changed in such a way that it now counts slices instead of pictures. A simple implementation has been chosen, where the design of the detector core is left untouched as much as possible. In the MPEG parsing part of the detector core a small modification translates the request for N pictures in a request for N*32 slices. This is good enough for both NTSC (normally 30 slices per picture) and PAL (normally 36 slices per picture), since also in the original situation a certain number of pictures does not define an exact amount of data.

Disclosed is a solution for connecting an existing MPEG2-compliant watermark detector (20), that accepts MPEG2 video data up to a certain data rate, to a PC-DVD drive. Problem is that the data rate of the standard IDE/ATAPI bus (3) is much higher than the watermark detector can handle. The solution is to store MPEG slices in a data buffer (214), and throw away (212) slices that do not completely fit in the buffer. Non-slice data is never removed. This results in an MPEG2-compliant stream at a lower rate which the detector (20) can handle.

1. A method of detecting a watermark in a digital information signal being transferred at a first data rate from one device to another device over a communication bus, the information signal being formatted in accordance with a given standard into a sequence of slices representing respective portions of said signal, the method comprising the steps of detecting the watermark by a watermark detector arranged to receive the information signal in accordance with said standard at a second data rate which is lower than said first data rate, said watermark detector being coupled to said communication bus through an interface circuit being arranged to carry out the steps of:
storing slices of said information signal into a buffer at said first data rate,
applying the data stored in said buffer to the watermark detector at said second data rate,
determining a degree of fullness of said buffer,
refraining from storing a slice of the information signal into said buffer if said degree of fullness exceeds a predetermined threshold.

2. The method as claimed in claim 1, wherein the slices have variable lengths.

3. The method as claimed in claim 1, wherein the information signal further includes non-slice data representing overhead information, the interface circuit being arranged to store said non-slice data in said buffer.

4. An arrangement for interfacing a watermark detector to a communication bus through which a digital information signal is transferred at a first data rate from one device to another device, the information signal being formatted in accordance with a given standard into a sequence of slices representing respective portions of said signal, and the watermark detector being arranged to detect the watermark in the information signal in accordance with said standard at a second data rate which is lower than said first data rate, the arrangement comprising:
buffer means for storing slices of said information signal at said first data rate and applying the data stored in said buffer to the watermark detector at said second data rate,
controller means arranged to determine a degree of fullness of said buffer and to refrain from storing a slice of the information signal into said buffer if said degree of fullness exceeds a predetermined threshold.

5. The arrangement as claimed in claim 4, wherein the slices have variable lengths.

6. A watermark detector comprising the arrangement as claimed in claim 4.

7. A memory device for playing back and/or recording media contents, the device having a communication bus for interfacing said device with a computer system, characterized in that the memory device comprises an arrangement as claimed in claim 4.

8. A computer system comprising a communication bus for interfacing said computer system with a drive for playing back and/or recording media contents, characterized in that the computer system comprises an arrangement as claimed in claim 4.
